(19) United States
(12) Patent Application Publication
(10) Pub. No.: US 2009/0065715 A1
(43) Pub. Date: Mar. 12, 2009

(54) Universal ultraviolet/ IR/ visible light emitting module

(76) Inventor: Lee Wainright, Bethlehem, PA (US)

Correspondence Address: Feldman Law Group, P.C., 12 E. 41St Street, New York, NY, 10017, US

(21) Appl. No.: 12/229,104

(22) Filed: Aug. 20, 2008

Related U.S. Application Data
(60) Provisional application No. 60/965,873, filed on Aug. 24, 2007.

(51) Int. Cl. G01J 3/10; G01N 21/64; F21L 4/00

(52) U.S. Cl. 250/504 R; 250/461.1; 362/157

(57) ABSTRACT

A miniature, battery operated plastic module designed to project at least three different frequencies of energy from light emitting diodes is described. A first frequency is between 390 nm-420 nm just above harmful Ultraviolet Frequencies, a second frequency is between 850 nm-1200 nm in the infrared band and a third frequency is for a visible white light. The light emitting module has a base unit, the unit including a pulsed LED that emits an ultraviolet wavelength of light adapted to focus on a surface having phosphorescence means on the surface to activate the phosphorescence. The light emitting module may also have a base unit which includes a pulsed LED that emits an infrared wavelength of light adapted to penetrate a particular atmosphere. The module may also provide optional power for external items in addition to the three frequencies.

### RELATED APPLICATIONS

This application claims the priority of U.S. Provisional Application No. U.S. Ser. No. 60/965,873, filed on Aug. 20, 2007.

### BACKGROUND OF THE INVENTION

1. Field of the Invention

The invention relates to light emitting devices, and more specifically, relates to LED light emitting devices for UV, IR, and visible light.

2. Description of the Prior Art

Light emitting devices implementing various techniques are known in the prior art. Ultraviolet lights have been used in a variety of light emitting devices in the prior art. The UV LEDs are generally applicable in smaller applications where only low voltage battery power is available. The prior art includes devices that use ultraviolet light generated by UV LEDs to excite phosphors in some portion of their structure.

Many safety vests used on construction sites, DOT, and emergency personnel are primarily made of nylon or other fabrics containing UV reactive phosphor material and some in use incorporate LEDs or incandescent bulbs to increase their visibility factor. These methods of lighting up safety apparel are inefficient, costly, and add considerable weight and bulk using several “AA” batteries to keep them lit over a few hours time.

The LEDs and other light sources are exposed beyond the surface of the actual apparel leaving them in “harm's way” when actively participating in construction or emergency work conditions. On top of that, wiring harnesses must be installed to attach the many lighted sources together and to a power source adding more areas that can cause malfunctions due to the constant bending and stress afforded to such systems.

In the prior art, in order to light up surface areas of items such as clothing or backpacks, suitcases, exterior portions of transport vehicles, and the like, lights of some nature whether they be incandescent, LED, or EL require extensive wiring and have high current draws which result in shortened battery life. Safety jackets presently used by airlines are made of UV phosphor reactive materials and have a flashing beacon attached that activates upon contact with water. Such devices do not have a way of shutting them off so their lifespan is quite short and they require a substantial amount of current compared to LEDs to operate.

Another problem that has not been adequately solved is having a device that transmits light energy for extended periods of time beyond days into weeks without need of battery replacement to assist rescuers in locating people who are stranded, hurt without mobility, lost, and are being sought after. In addition, prior art methods contain physical switches mounted on exterior battery cases that are a big concern with electronic failure, are not waterproof, and can be damaged easily.

There is a need of a device that can emit all three frequencies of UV, IR and visible light with very light weight batteries and that can be very easily switched off and on. There is also need of a light emitting device that has less wiring arrangements and that can provide external power to drive other devices.

### SUMMARY OF THE INVENTION

A light emitting module is described that has a base unit, the unit including a pulsed LED that emits an ultraviolet wavelength of light adapted to focus on a surface having phosphorescence means on the surface to activate the phosphorescence. In another embodiment, the light emitting module may also have a base unit which includes a pulsed LED that emits an infrared wavelength of light adapted to penetrate a particular atmosphere.

A light emitting module unit may also have a body shell. The base unit may enclose an application specific integrated circuit (ASCI), a PCB, a magnetic reed switch, a pair of opposed UV LEDs to activate phosphors on a surface, and a pair of coin cells. An outer surface of the base unit is coated with a ferromagnetic material and the base plate includes a magnet that is encapsulated within a pair of rubber sheets. The body shell covers the base unit and has a pair of windows.

The base unit includes a layer of ferromagnetic material. The module has a base plate that includes a magnet that is encapsulated within a pair of rubber sheets. The base plate has two positions. In a first position, the base plate is removably magnetically securable with the ferromagnetic surface of the base unit to switch on the reed switch by the virtue of a magnet in the base plate. In a second position, the base plate is separated from the ferromagnetic base unit to switch off the reed switch. The magnet in the base plate is in close proximity with the reed switch in the first position of the base plate.

The UV LEDs disperse UV light energy in the first position of the base plate. The windows of the shell emit the UV energy outwards through the windows in the first position of the base plate. The UV LEDs flash on and off at a high rate of (100+ Hertz rate) to save 90% on current draw.

In another embodiment of the light emitting module of the present invention, the base unit of the flange is advantageously used to secure the module with a docking station on a buckle. The buckle includes a first part and a second part. The first part includes the docking station to securely couple the UV projecting module with the flange of the base unit by a snap fit. The first part also includes the UV projection module and a bottom opening and a set of approximately rectangular windows. The second part of the buckle has a second set of windows and a protrusion that includes the magnet. The second part is inserteable into the first part through the opening of the first part.

The buckle has two positions. In a first position of the buckle, the first part is secured with the second part to switch on the reed switch by the virtue of a magnet in the second part, and in a second position, the first part is disassembled from the first part to switch off the reed switch. The magnet in the base plate is in close proximity with the reed switch in the first position of the buckle. The body shell preferably includes a UV phosphorescent plastic material that emits light energy from the excess UV energy expelled from the sides of the UV LEDs.

In an embodiment of activating and deactivating the LEDs module, the base unit includes a swivel, a pair of contacts, a pair of blocks, and connections for display options. The connections are activated by moving the swivel on to respective contacts.

In another embodiment of the light emitting module, the base unit encloses an application specific integrated circuit (ASCI), a PCB, an Infrared LED, and a White LED positioned facing 90° from the orientation of a pair of opposed UV LEDs to shine outward. In one embodiment, the shell covers the three LEDs and three sets of batteries that provide power for the internal function. The module includes at least two push buttons/switches for lighting the respective LEDS and to supply power to an external device.

The first push button is depressed for a first time to blink the UV LEDs on and off along with the IR LED. The first push button is depressed for a second time to shut off the IR LED and UV LEDs and to turn on the white LED to act as a flashlight. The first push button is depressed for a third time to shut the power off to all LEDs. The second push button is depressed for the power output through a jack to power external items. The module has at least two sensors that are installed to provide valuable information and save power in the module.

### BRIEF DESCRIPTION OF THE DRAWINGS

FIG. 1A is a top perspective of a light emitting module in accordance with the present invention;

FIG. 1B is a top perspective of a dismantled rubber plate of the module of FIG. 1;

FIG. 2 is a top view of the module of FIG. 1;

FIG. 3 is an ASCI circuit of the module of FIG. 1;

FIG. 4 is a front view of a buckle of the present invention in a first dissembled position;

FIG. 5 is a front view of the buckle FIG. 4 in a second assembled position;

FIG. 6 is a top perspective view of dissembled parts of a first embodiment of the module of FIG. 1;

FIG. 7 is a bottom view of an embodiment of an activation and deactivation mechanism of the module of present invention;

FIG. 8 is a top view of the activation and deactivation of module of FIG. 7; and

FIG. 9 is a side view of a third embodiment of the module of the present invention.

### DETAILED DESCRIPTION OF THE INVENTION

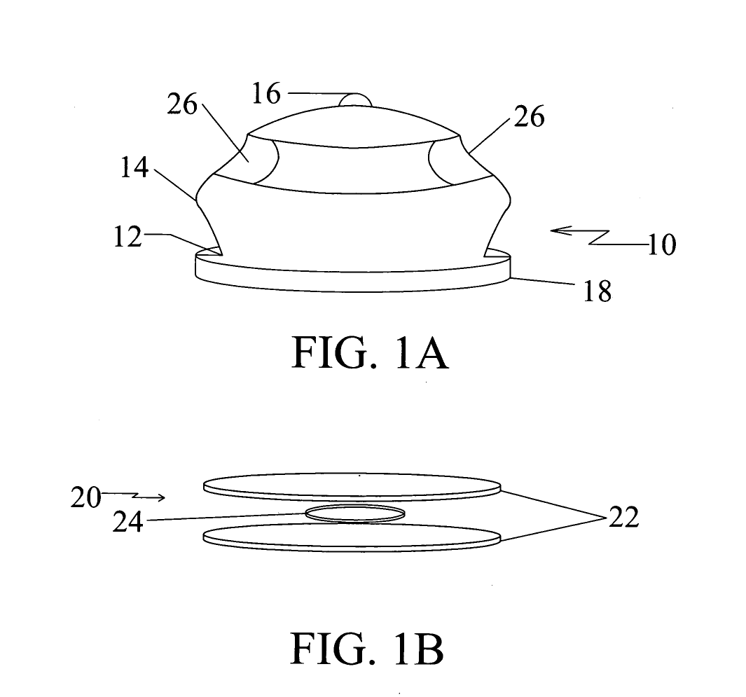

Referring to FIGS. 1A and 1B, a light emitting module 10 in accordance with a preferred embodiment of the present invention is shown. The module 10 includes a cylindrical base unit 12 and a body shell 14. The body shell 14 is securely coupled with the base unit 12. A loop 16 is securely coupled with the body shell 14 at a predefined position. The cylindrical base 12 defines a space for positioning a plurality of components of the module 10 at predefined positions. An outer surface of the base unit 12 is advantageously coated with a ferromagnetic material.

A rubber gasket is preferably positioned between the base unit 12 and the body shell 14. A bottom portion of the cylindrical base 12 protrudes outwards to define a circular flange 18. The module also includes a rounded base plate 20 that is defined by a pair of rounded rubber sheets 22 that encapsulate a rounded flat magnet 24. The thin rubber sheets 22 are coupled with each other with known sticking materials in the art.

The magnetic base plate has two positions. In a first position, the base plate 20 is positioned on the ferromagnetic surface of the base unit 12. In a second position, the base plate is dissembled from the base unit. In a preferred embodiment, the diameter of the magnetic base plate 20 is approximately identical with the diameter of base unit 12. Magnetic base plate 20 is removably secured with the outer ferromagnetic surface of the base unit 12. The body shell 14 defines an opposed pair of plastic windows 26. Each of the plastic windows 26 preferably includes a lens.

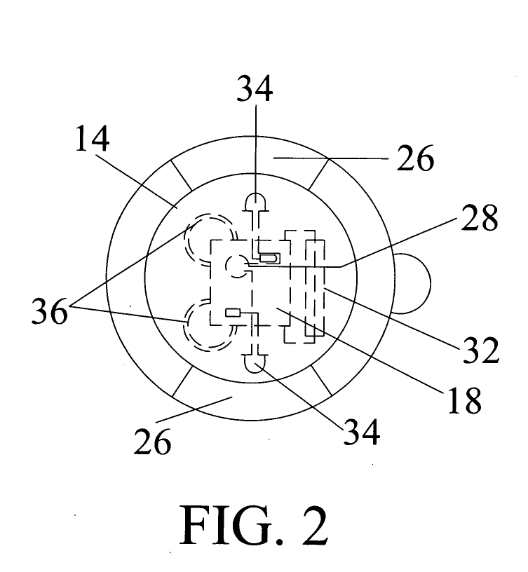

Referring to FIG. 2, the shell covers an application specific integrated circuit (ASCI) 28, a PCB 30, a magnetic reed switch 32, a pair of opposed LED 34 to activate phosphors on a surface, and a pair of coin cells 36 that are positioned in base unit 12. The two opposed pulsed UV LEDs 34 emit UV energy outward through windows when the magnetic reed switch 32 is closed. The pulsed LEDs emits an ultraviolet wavelength of light adapted to focus on a surface having phosphorescence means on the surface to activate the phosphorescence The magnetic switch 32 is closed by a magnetic field of a magnet. The coin cells are, for example, model 2032 or AAAA batteries to drive the electronics and LEDs and to use the power source in conjunction with larger models.

In the first position of the base plate 20, the reed switch is turned on when the magnet 24 is brought into close proximity to the reed switch 32. The rubber plate 20 with magnet 24 is securely positioned on the base unit in close proximity with the reed switch 32 by virtue of the ferromagnetic material on the outer surface of the base unit and the magnetic field of the magnet 24 of the base plate 20. In the second position of the base plate, the magnetic reed switch 32 is turned off as soon as the magnet 24 in the base plate 20 is moved from the first position to disassemble the ferromagnetic base and the base plate.

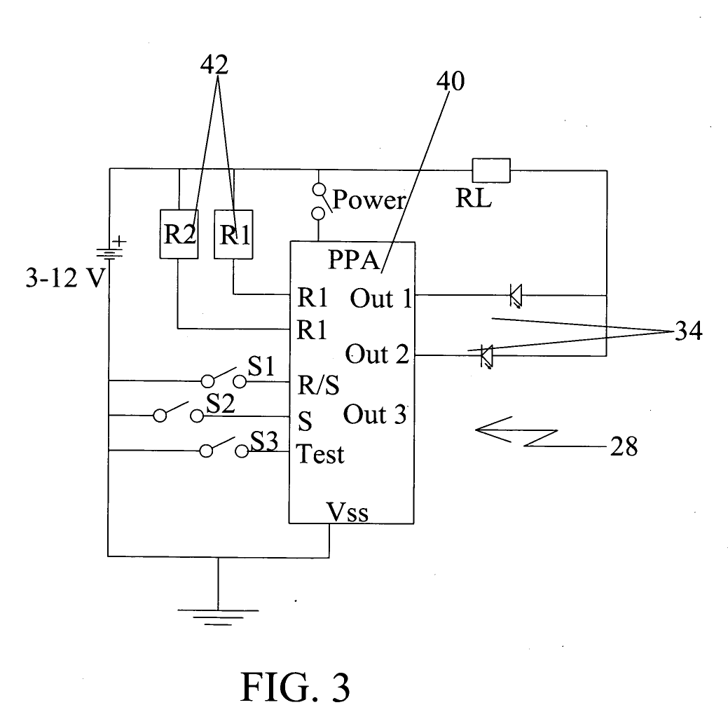

Referring to FIG. 3, the ASCI circuit 28 meant to alternately switch on two LEDs once the power is switched on from the reed switch 32 in accordance with the present invention is described. The circuit 28 includes a PIC chip processor 40 that has a routine in hex code in memory to sequence the flashing of LEDs 34, but other methods such as blinking LEDs are also contemplated. The LEDs 34 flash in such a manner as to conserve excess current draw normally expected in the flashing of LEDs 34 on and off. By switching the LEDs 34 on and off at a high rate (100+ Hertz rate) during the “On” mode, up to 90% savings on current draw may be achieved.

The technique is known as “Quiescent Technology.” Once the power is switched on, the outputs to the two LEDs 34 are fed by two limiting resistors 42 through the PIC chip processor 40 and into the LEDs 34. Reset, Set, and test switches S1, S2, and S3 indicated by 44 are kept in the open position as shown. The circuit meant to drive the LEDs 34 is converted into an ASIC and is represented by COB 28 (FIG. 2).

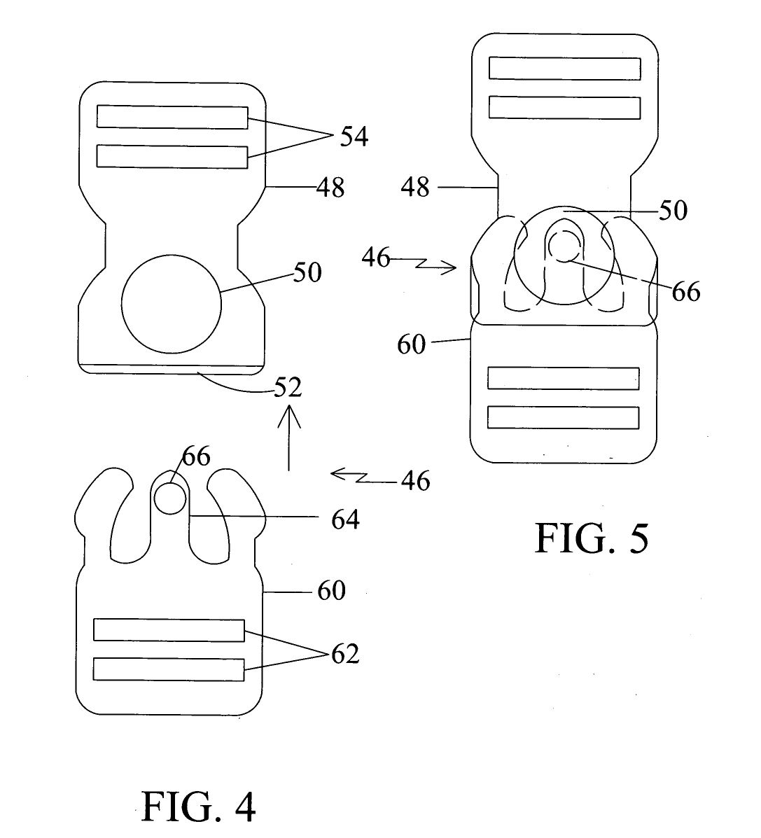

Now referring to FIGS. 4 and 5, a buckle 46 for coupling the UV projection module 10 in accordance with the preferred embodiment of the present invention is shown. The buckle 46 at least has two parts that are removably assembled with each other in a predefined position. A first part 48 includes a UV projection module docking station 50, a bottom opening 52, and a first set of approximately rectangular windows 54. The buckle is preferably made of, but not limited to, plastic or fiber material.

The second part 60 of the buckle 46 has a second set of windows 62 and a protrusion or tongue 64 that includes a rounded magnet 66. In one embodiment, the second set of windows 62 is approximately identical to the first set of windows 54. Buckle 46 has two positions. In a first position, the two parts 48 and 60 are separated from each other. In a second position, the first part 48 and the second part 60 are assembled to define the buckle 46.

The second part 60 is removably inserted into the first part 48 with a snap fit so that the magnet 66 is positioned under the docking station 50 of the first part 48. In the second position, the magnet 60 is in close proximity with the reed switch 32 in the module 10. The second part 60 is inserted into the first part 48 through the opening 52.

It is, however, understood that the buckle 46 is preferably used where the light emitting module 10 excludes the magnetic plate 20. The light emitting module 10 without the base plate 20 is securely coupled with the docking station 50 with the flange 18. In the first position of the buckle 46, the second part 60 is disassembled from the first part 48. In the second position of the buckle, the second part 60 is assembled with the first part 48 such that the magnet 66 is positioned under module 10 in close proximity with reed switch 32.

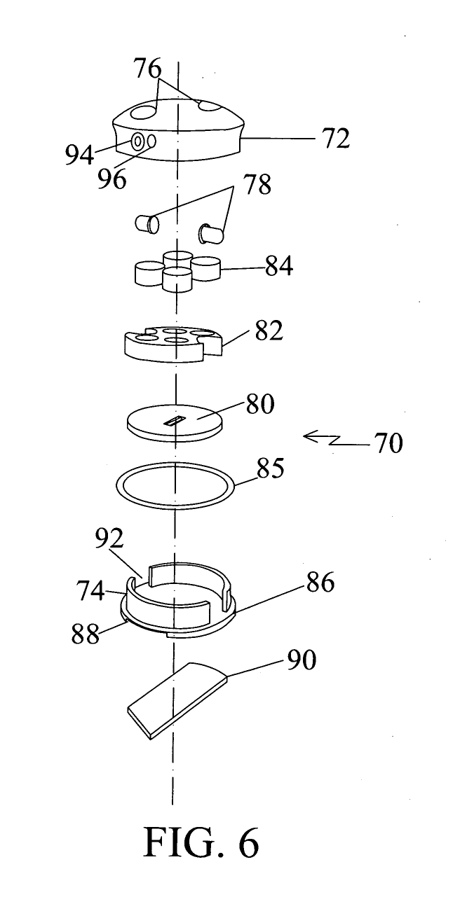

Referring to FIG. 6, another embodiment in accordance with the present invention is described. In this one embodiment, the light projecting module 70 includes a dome shaped body shell 72 that is preferably threadably coupled with the cylindrical base unit 74 in a predefined position. The body shell 72 includes a pair of opposed windows 76. The module 70 also includes a pair of opposed pulsed UV LEDs 78 that are positioned under respective windows 76 to emit light through the respective windows 76 on the body shell 72.

The dome shaped body shell 72 preferably includes a UV phosphorescent plastic material that emits light energy from the excess UV energy expelled from the sides of the pulsed UV LEDs 78 inside. Body shell 72 includes PCB with chip on board electronics, battery holder 82, batteries 84 and a gasket 85, however, other styles and battery configurations are also contemplated. The base 74 has a flange 86 that defines a slot 88. A slide attachment 90 is provided to secure the module 70 to a surface is slid into the slot 88. The wall of the base defines a pair of approximately rectangular grooves 92. An Infrared pulsed LED 94 and White pulsed LED 96 are positioned facing 90° from the orientation of the pulsed UV LEDs 78 to shine outward from the top of the module 70.

Steps involved in a preferred method of assembly of the module will be described. Initially the gasket 85 is positioned on the flange 86. The PCB 80 including chip on board (COB) electronics are mounted at the base 74 of the module 70. The batteries 84 are positioned in the slots of the battery holder 82. Battery holder 82 is placed under the dome shell 72 with batteries 84 placed inside. It is, however, understood that other types of batteries including “AAAA” types are applicable with appropriate battery holders 82.

The body shell 72 is threadably coupled with the cylindrical base 74 so that the grooves 92 of the base and the windows 76 in the body shell are approximately aligned. The slide attachment 90 is slid into the slot provided to secure the module to a surface.

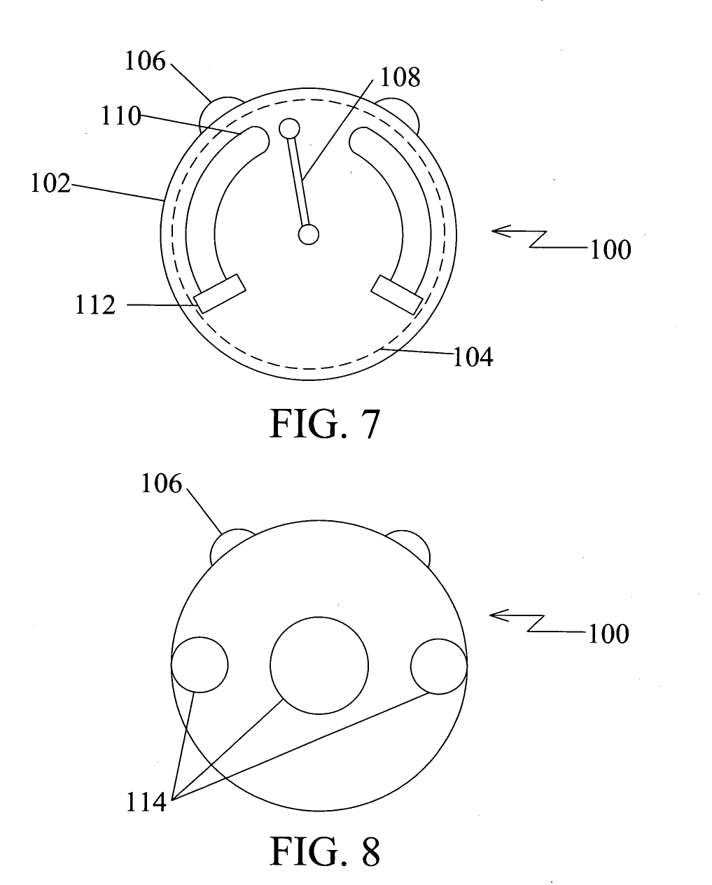

Referring to FIGS. 7 and 8, an embodiment of activation and deactivation of the pulsed LEDs of the present invention is shown. In this one embodiment, the light projecting module 100 includes an airtight shell 102, a base unit 104 and a pair of loops 106. Base 104 includes a movable swivel mechanism 108 that activates and deactivates the module 100. A pair of contacts 110 is embedded into the base 104. Base 104 has a pair of blocks 112 and connections for display options.

Each of the contacts 110 has a perimeter of plastic material. The shell 102 includes internal printed material, for example, paper, plastic, UV Fluorescent or phosphorescent material, 3M's plastic reflective material. Shell 102 includes a plurality of light windows 114 to escape from red, white, IR, or any other colored LEDs mounted beneath the respective window. The connections are activated by the swivel mechanism 108 preferably by moving the swivel onto one of the contacts 110. The swivel contact is movable on the outside of the plastic perimeter to make contact between positive and negative.

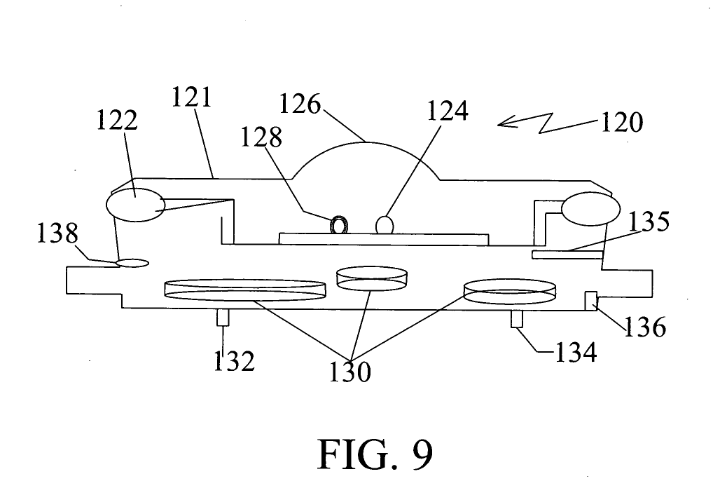

Referring to FIG. 9, another embodiment of the light projection module of the present invention is described. In this one embodiment, a base unit of the module 120 includes an application specific integrated circuit (ASCI), a PCB, at least two push switches for lighting one or more pulsed UV LEDS 122, white LED 124 and IR LED 128 covered by a shell 121. The module 120 includes both output from UV LEDs 122 & White LEDs 124 with a molded curved lens 126 in shell 127 above area defined by white LED 124 and an IR LED 128.

In one embodiment, the shell 121 covers all of the three pulsed LEDs and three sets of batteries 130 provide power for the internal functions such as blinking the UV LEDs 122 on and off along with the IR LED 128 by depressing a first push-button switch 132 once. Upon pushing the switch 132 a second time, the IR LED 128 and UV LEDs 122 are shut off while turning on the white LED 124 to act as a flashlight. One more depression of the switch 132 shuts the power off to all LEDs 122, 124 and 128.

A second switch 134 allows for the power output through jack 135 to power external items to flash on and off, or keep constant light output via a PCB controller mounted inside. The module 120 also includes at least two sensors 136 that are installed to provide valuable information and save power in the module 120. A LED power level indicator 138 warns a user about when power is about to die and a photo-sensor shuts off external power to the jack 135 when intense light is detected to conserve power.

Now referring to FIGS. 1 to 9, in operation, the magnetic base plate is secured with the ferromagnetic base. The magnetic field of the base plate 20 activates the reed switch 32 to close the circuit and the alternating flash routine circuit is initiated as long as reed switch 32 stays in close proximity with the magnet 24 of the base plate 20.

In another embodiment, the module 10 is coupled advantageously with the docking station 50 of the buckle 46. The second part 60 of the buckle 46 is inserted in the first part 48 to position the magnet 66 below the reed switch 32. The reed switch 32 is activated to close the circuit and to start the operation of the module 10.

The radiating UV frequency of the module 10 disclosed in the present invention falls between 385 and 400 nm. The present invention has a first frequency between 390 nm-420 nm just above harmful ultraviolet frequencies, a second frequency is between 850 nm-1200 nm in the infrared band, and a third frequency is for a visible white light. It is, however, understood that the harmful activity drops remarkably at the 320 nm frequency and is not effective above that frequency. The present invention operates at frequencies between 390 nm and 420 nm. There is no danger of any negative radiation effects. The “Quiescent Technology” in the circuit 17 serves to extend battery life up to 1000% of normally expected lifespan.

The ferromagnetic effect of the base advantageously secures the module to clothing, plastic, cardboard, metal and any other material consisting of rubber. The flange 18 is used to secure the module 10 to docking station 50. It is, however, understood that the module 10 could be fastened to a toy, desk sculpture, or any other desired object. The base unit 12 with the magnetic base plate 20 can become the mount for the module to attach to apparel, boxes, windows, and any substrate surrounded by UV phosphor printed, painted, or impregnated materials and at the same time, activate the module.

The loop is provided for inserting chains, wires, strings, etc. The lenses in the windows 76 are designed to disperse the UV energy across a broader area.

The slot 88 is provided on the base 74 of the module 70 to allow a variety of connection attachments to be inserted. These may range from a pin, magnet, Velcro, self-stick, etc. attached to a sliding platform allowing the module to attach to many different types of surfaces. A rubber gasket 85 prevents liquids from entering the module 70.

The stops or solid blocks 112 of plastic or other material prevent the swivel mechanism 108 from moving too far and also act to secure the swivel. The pair of loops 106 is used for attaching a lanyard to hang the module around one's neck, a hook, nail, or whatever other support is available. The pulsed UV LEDs project near UV energy approximately in a range 390-410 nm outward onto the surrounding surfaces allowing ultraviolet phosphorescent mineral content of surrounding surface to emit light from, for example, drawn patterns, painted patterns, filled areas, tapes, or alphanumeric characters.

The light emitting module disclosed in the present invention is useful in normal darkened environment, hostile, dust-filled, poor-visibility environment with extremely low current draw. The removably insertable magnet for the activation advantageously replaces use of external switches. The plug and jack arrangement provided in the module 120 enables the module 120 to supply power to external items that operate on voltages between 318 VDC. The module 10 is tiny enough to be mounted on a belt pack, vest, back pack, jacket, raincoat etc.

The self contained batteries 36 are very light weight. The batteries 36 are removable and replicable. The infrared energy projected from the module 10 is able to penetrate many opaque substances and materials to allow observers using FLIR (Forward Looking Infrared) equipment such as night vision security cameras, goggles, or portable units used by hunters, and security personnel to see it from afar in low-visibility environments such as found in coal mines, poor weather conditions, dust storms, and smoke filled areas, etc.

Users have the convenience of orienting the direction of the two opposing flashing LEDs when they insert the module 10 into the docking station 50 of buckle 46 thus enabling them to decide what area of the item they wish to light up. When the buckle 46 is unfastened, the magnet 66 is drawn out of the docking station 50 and away from the reed switch 32, thus shutting off the LEDs.

This allows for the elimination of any exposed wiring or physical switches to be used as a part of this device. The use of buckle 46 of the present invention is intended for use with fireman waterproof coats, DOT safety vests, police and emergency worker vests, as well as duffel bags, securing straps for transport vehicles, sails, belt packs, and back packs.

The white LED 124 mounted inside the module may be activated turning on the white lighted LED 124 to act as an emergency flashlight. Although the IR LED 128 cannot be seen without use of special detection equipment, it is designed to blink a high intensity flash in the IR frequency spectrum to allow searchers/rescuers/emergency personnel to locate the device through environments such as dust-filled, smoke laden, blizzard, and other conditions that make it impossible to see normal light in the visible spectrum with the naked eye. The module 10 can be used to project ultraviolet energy across the exterior portions of a garment treated with UV reactive phosphors that in turn emit light, intense infrared frequency to penetrate opaque materials and dust-filled environments to be seen by special IR detection devices, and a white light for personal emergency uses.

It will be understood by those skilled in the art that many variations and modifications may be made in the present invention without departing from the spirit and scope of the invention.

What is claimed is:

1. A light emitting module comprising:
a unit, comprising a pulsed LED that emits an ultraviolet wavelength of light adapted to focus on a surface having phosphorescence means on the surface to activate the phosphorescence.

2. The light emitting module of claim 1, wherein the base unit further comprises an application specific circuit (ASCI), a PCB, a magnetic reed switch, to activate phosphors on a surface, and a pair of coin cells,
an outer surface of the base unit, the outer surface is coated with a ferromagnetic material;
a base plate, the base plate includes a magnet;
a body shell having a pair of windows covering the base unit;
a first position of the magnetic base plate, in which the base plate is removably magnetically securable with the ferromagnetic surface of the base unit to switch on the reed switch by the magnet in the base plate; and
a second position of the magnetic base plate, in which the base plate is separable from the ferromagnetic base unit to switch off the reed switch.

3. The module of claim 2, wherein the body shell includes a UV phosphorescent plastic material that emits light energy from the excess UV energy expelled from the side of the LED.

4. The module of claim 1, wherein the LED flash on and off at a high rate of (100+ Hertz rate) to save 90% on current draw.

5. A light emitting module comprising:
a base unit, comprising a pulsed LED that emits an infrared wavelength of light adapted to penetrate a particulate atmosphere.

6. The light emitting module of claim 5, wherein the base unit further comprising:
an application specific circuit (ASCI), a PCB, a magnetic reed switch, to activate phosphors on a surface, and a pair of coin cells.
a flange, the flange defined by a bottom portion of the base unit;
a body shell having a pair of windows covering the base unit;
a buckle, the buckle includes a first part and a second part, the first part includes a UV projecting module docking station to securely couple the UV projecting module with a flange;
a first position of the buckle, in the first position, the first part is secured with the second part to switch on the reed switch the magnet in the second part; and
a second position of the buckle, in the second position, the first part is disassembled from the first part to switch off the reed switch.

7. The module of claim 6, wherein the body shell includes a UV phosphorescent plastic material that emits light energy from the excess UV energy expelled from the side of the UV LED.

8. The module of claim 6, wherein the first part includes the UV projection module docking station, a bottom opening, and a set of approximately rectangular windows.

9. The module of claim 6, wherein the second part of the buckle has a second set of windows and a protrusion that includes the magnet.

10. The module of claim 6, wherein the second part is inserted into the first part through the opening of the first part.

11. The module of claim 6, wherein the magnet in the base plate is in close proximity with the reed switch in the first position of the buckle.

12. The module of claim 2, wherein the base unit includes a swivel, a pair of contacts, a pair of blocks, and connections for display options.

13. The module of claim 12, wherein the connections are activated by moving the swivel on to respective contacts.

14. A module comprising:
a base unit, the base unit encloses an application specific circuit (ASCI), a PCB, an Infrared LED and a White LED positioned facing 90° from the orientation of a UV LED to shine outward;
a shell, the shell covers the three LEDs and at least or more one set of batteries that provide power for the internal functions; and
at least one or more push switches for lighting the respective LEDS and to supply power to an external device.

15. The module of claim 14, wherein the first push button is depressed for a first time to blink the UV LED on and off along with the IR LED.

16. The module of claim 14, wherein the first push button is depressed for a second time to shut off the IR LED and UV LED and to turn on the red or white LED to act as a flashlight.

17. The module of claim 14, wherein the first push button is depressed for a third time to shut the power off to all LEDs.
